(19) United States
(12) Patent Application Publication
(10) Pub. No.: US 2026/0067947 A1
(43) Pub. Date: Mar. 5, 2026

(54) APPARATUS AND METHOD FOR ESTABLISHING A SIDELINK COMMUNICATION OVER AN UNLICENSED CARRIER

(71) Applicant: Lenovo (Singapore) Pte. Limited, Singapore (SG)

(72) Inventors: Alexander Golitschek Edler von Elbwart, Darmstadt (DE); Karthikeyan Ganesan, Kronberg Im Taunus (DE); Joachim Löhr, Wiesbaden (DE); Prateek Basu Mallick, Dreieich (DE)

(73) Assignee: Lenovo (Singapore) Pte. Limited, Singapore (SG)

(21) Appl. No.: 19/102,964

(22) PCT Filed: Aug. 10, 2023
(86) PCT No.: PCT/IB2023/058115

§ 371 Date: Feb. 11, 2025

Related U.S. Application Data
(60) Provisional application No. 63/397,085, filed on Aug. 11, 2022.

(51) Int. Cl. H04W 74/08; H04W 72/25

(52) U.S. Cl. CPC H04W 74/0866; H04W 72/25

(57) ABSTRACT

A user equipment (UE), processor and method are provided for sidelink communication. The method includes determining (602) a type of sidelink transmission. Unlicensed channel access parameters are determined from multiple sets of unlicensed channel access parameters, each set being associated with one of multiple priority classes, based upon the determined type of sidelink transmission (604). A channel access procedure for determining whether a channel in the unlicensed carrier is clear is performed, where the channel access procedure uses parameters associated with the selected one of the multiple sets (606). When the channel in the unlicensed carrier is determined as being clear, the UE is authorized to make use of the channel for a sidelink transmission (608).

### FIELD

The present disclosure is directed to the establishment of a sidelink communication over an unlicensed carrier, and more particularly to the management of a contention window size to be used in identifying whether a channel in the unlicensed carrier is clear.

### BACKGROUND

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Long Term Evolution (LTE), Universal Mobile Telecommunications Service (UMTS), Global System for Mobile Communication (GSM), and/or Enhanced Data GSM Environment (EDGE).

As part of functioning within many communication networks, such as cellular communication networks, a large part of supporting communications can often involve the use of spectrum resources, that are largely auctioned/licensed for use to a specific service provider through appropriate governing authorities. The amount of licensed spectrum that a service provider has obtained the rights to use often correlates to the overall amount of information throughput that can be more directly supported. As a way of expanding capabilities and information throughput, service providers have been increasingly looking toward unlicensed frequencies, that are available for general use, as a way to support enhanced functionality and communication throughput.

Communications in an unlicensed portion of the spectrum can sometimes involve a form of communication referred to as listen before talk (LBT). In LBT, a radio transmitter will often sense the radio environment for activity from other sources in the radio channel space of interest (listen), before attempting to transmit (talk), after the radio channel space is determined to be relatively clear of other already existing communications. In an effort to more fairly manage the sharing of the unlicensed portion of the spectrum for the purposes of supporting communications for potentially multiple different users, various parameters have been established which help to balance how often a user can make use of an unlicensed carrier, as well as when a particular user makes use of the unlicensed carrier, how long they may transmit before they need to get back in line and wait for the radio channel space to become available, again (i.e. listen). These parameters have traditionally been better defined in an environment, where a user is communicating with the network via an unlicensed carrier, but are relatively more modestly defined in instances where the user is communicating more directly with another user without relaying their data via the network. Communications which use the unlicensed spectrum in a more user to user direct fashion are sometimes referred to as sidelink communications.

Such a form of communication in some instances may better facilitate the establishment of an ad-hoc network, where it may be beneficial to establish a connection with other nearby devices without needing any network involvement. While such a service could be beneficial to users using a handset for communications including instances in which network service may not be available to one or both of the parties involved in a particular communication, other devices including smart devices, robots or other gadgets can use such a feature to communicate with other nearby devices for sharing information, such as sensor information, and/or for enabling the devices to coordinate their activity with the other nearby devices, such as for traffic management and movement on a highway involving multiple vehicles. The use of communications via an unlicensed portion of the spectrum can also be used as a means of increasing data throughput for some activities that can be more data intensive, such as virtual and/or augmented reality type applications.

In order to help ensure that a particular user does not monopolize the use of the shared unlicensed carrier to the detriment of other users that are also similarly interested in using the same unlicensed portion of the spectrum, various parameters have been established that help define how any particular user can make use of the shared unlicensed frequencies. One such parameter is the use of a contention window size, having a defined value which can vary over time. The contention window size establishes a period of time that a user needs to wait before the user can attempt to make use of the channel space. During this wait period, the channel space is available to be used by other users, who are likely managing their own wait times. By managing the various parameters governing the use of the shared space, it is hoped that effective sharing between all of the desired users can be better managed while better optimizing the overall use of the shared resource.

The present inventors have recognized that in some instances it may be desirable to select between multiple sets of unlicensed channel access parameters depending upon a particular determined type of sidelink transmission. In at least some instances, this can be used to beneficial effect to help better manage and/or prioritize the sharing of the unlicensed portion of the spectrum between multiple potential users.

### SUMMARY

The present application provides a user equipment (UE) for sidelink communication. The UE includes at least one controller coupled with at least one memory and configured to cause the UE to determine a type of sidelink transmission. The controller determines unlicensed channel access parameters from multiple sets of unlicensed channel access parameters, each set of unlicensed channel access parameters being associated with one of multiple priority classes, based upon the determined type of sidelink transmission. The controller performs a channel access procedure using a transceiver for determining whether a channel in an unlicensed carrier is clear, where the channel access procedure uses parameters associated with the respective selected one of the multiple sets. When the channel in the unlicensed carrier is determined as being clear for a number of sensing slots in accordance with at least one channel access parameter, the UE is authorized to make use of the channel for a sidelink transmission.

According to another possible embodiment, a processor for wireless communication in a user equipment (UE) for sidelink communication is provided. The processor includes at least one controller coupled with at least one memory and configured to cause the processor to determine a type of sidelink transmission. The controller determines unlicensed channel access parameters from multiple sets of unlicensed channel access parameters, each set of unlicensed channel access parameters being associated with one of multiple priority classes, based upon the determined type of sidelink transmission. The controller performs a channel access procedure using a transceiver for determining whether a channel in an unlicensed carrier is clear, where the channel access procedure uses parameters associated with the respective selected one of the multiple sets. When the channel in the unlicensed carrier is determined as being clear for a number of sensing slots in accordance with at least one channel access parameter, the UE is authorized to make use of the channel for a sidelink transmission.

According to a further possible embodiment, a method in a user equipment (UE) for sidelink communication is provided. The method includes determining a type of sidelink transmission. Unlicensed channel access parameters are determined from multiple sets of unlicensed channel access parameters, each set of unlicensed channel access parameters being associated with one of multiple priority classes, based upon the determined type of sidelink transmission. A channel access procedure for determining whether a channel in an unlicensed carrier is clear is performed, where the channel access procedure is using parameters associated with the respective selected one of the multiple sets. When the channel in the unlicensed carrier is determined as being clear for a number of sensing slots in accordance with at least one channel access parameter, the UE is authorized to make use of the channel for a sidelink transmission.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is an example of a sidelink slot structure with 14 symbols available;

FIG. 3 is a further example of a sidelink slot structure, also with 14 symbols available;

FIG. 4 is a still further example of a sidelink slot structure, one which has 13 symbols available;

FIG. 5 is an exemplary resource pool structure;

FIG. 6 is a flow diagram in a user equipment for establishing a sidelink communication including one or more sidelink transmissions over an unlicensed carrier; and

FIG. 7 is an example block diagram of an apparatus according to a possible embodiment.

### DETAILED DESCRIPTION

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide support for the establishment of a sidelink communication over an unlicensed carrier, including the management of a contention window size to be used in identifying whether a channel in the unlicensed carrier is clear.

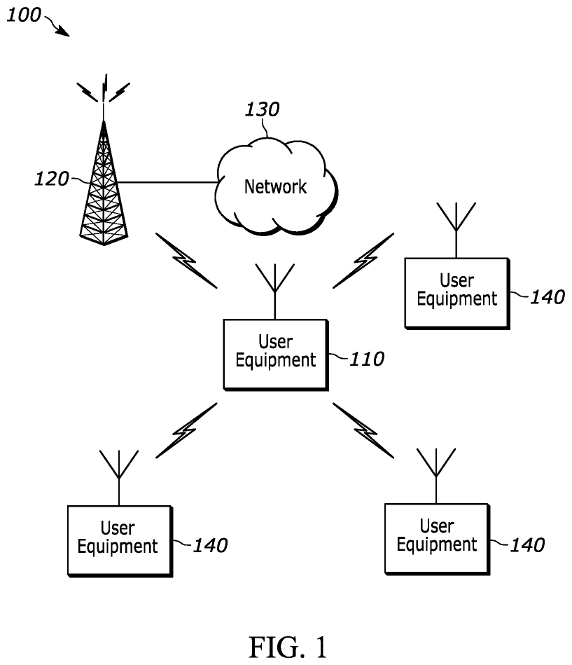

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130.

The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In addition to and/or alternative to communicating with the network 130, the wireless communication device 110 may sometimes be able to communicate more directly with other wireless communication devices, such as user equipment 140. An example of this type of communication can sometimes be called peer-to-peer, and can sometimes relate to a sidelink type communication. In some instances, this can involve a targeted communication with a single entity, which is sometimes referred to as a unicast. In some instances, this can involve a targeted communication with multiple entities, which is sometimes referred to as a multi-cast. In some instances, this can involve an untargeted communication, which is available to any entity within transmission/reception range, which is sometimes referred to as a broadcast. In the illustrated embodiment, the base station 120 and the other user equipment 140 are potential communication targets of the wireless communication device 110.

Up to Release 17, only downlink (DL) and uplink (UL) rules for unlicensed channel access have been established. For sidelink channel access, new channel access rules need to be established.

### From 3rd Generation Partnership Project (3GPP) TS 37.213

### 4.1.1 Type 1 DL Channel Access Procedures

This clause describes channel access procedures to be performed by an eNB/gNB where the time duration spanned by the sensing slots that are sensed to be idle before a downlink transmission(s) is random. The clause is applicable to the following transmissions:
Transmission(s) initiated by an eNB including physical downlink shared channel (PDSCH)/physical downlink control channel (PDCCH)/enhanced physical downlink control channel (EPDCCH), or
Any transmission(s) initiated by a gNB.

The eNB/gNB may transmit a transmission after first sensing the channel to be idle during the sensing slot durations of a defer duration T_{d} and after the counter N is zero in step 4. The counter N is adjusted by sensing the channel for additional sensing slot duration(s) according to the steps below:
1) set N=Nᵢₙᵢₜ, where Nᵢₙᵢₜ is a random number uniformly distributed between 0 and CWₚ, and go to step 4;
2) if N>0 and the eNB/gNB chooses to decrement the counter, set N=N−1;
3) sense the channel for an additional sensing slot duration, and if the additional sensing slot duration is idle, go to step 4; else, go to step 5;
4) if N=0, stop; else, go to step 2.
5) sense the channel until either a busy sensing slot is detected within an additional defer duration T_{d} or all the sensing slots of the additional defer duration T_{d} are detected to be idle;
6) if the channel is sensed to be idle during all the sensing slot durations of the additional defer duration T_{d}, go to step 4; else, go to step 5;

If an eNB/gNB has not transmitted a transmission after step 4 in the procedure above, the eNB/gNB may transmit a transmission on the channel, if the channel is sensed to be idle at least in a sensing slot duration Tₛₗ when the eNB/gNB is ready to transmit and if the channel has been sensed to be idle during all the sensing slot durations of a defer duration T_{d} immediately before this transmission. If the channel has not been sensed to be idle in a sensing slot duration Tₛₗ when the eNB/gNB first senses the channel after it is ready to transmit or if the channel has been sensed to be not idle during any of the sensing slot durations of a defer duration T_{d} immediately before this intended transmission, the eNB/gNB proceeds to step 1 after sensing the channel to be idle during the sensing slot durations of a defer duration T_{d}.

The defer duration T_{d} consists of duration T_{f}=16 μs immediately followed by mₚ consecutive sensing slot durations Tₛₗ, and T_{f} includes an idle sensing slot duration Tₛₗ at start of T_{f}.
CW_{min,p}≤CWₚ≤CW_{max,p} is the contention window. CWₚ adjustment is described in clause 4.1.4.
CW_{min,p} and CW_{max,p} are chosen before step 1 of the procedure above.
mₚ, CW_{min,p}, and CW_{max,p} are based on a channel access priority class p associated with the eNB/gNB transmission, as shown in Table 4.1.1-1.

An eNB/gNB shall not transmit on a channel for a Channel Occupancy Time that exceeds T_{m cot,p} where the channel access procedures are performed based on a channel access priority class p associated with the eNB/gNB transmissions, as given in Table 4.1.1-1.

If an eNB/gNB transmits discovery burst(s) as described in clause 4.1.2 when N>0 in the procedure above, the eNB/gNB shall not decrement N during the sensing slot duration(s) overlapping with discovery burst(s).

A gNB may use any channel access priority class for performing the procedures above to transmit transmission(s) including discovery burst(s) satisfying the conditions described in this clause.

A gNB shall use a channel access priority class applicable to the unicast user plane data multiplexed in PDSCH for performing the procedures above to transmit transmission(s) including unicast PDSCH with user plane data.

For p=3 and p=4, if the absence of any other technology sharing the channel can be guaranteed on a long term basis (e.g. by level of regulation), T_{m cot,p}=10 ms, otherwise, T_{m cot,p}=8 ms.

TABLE 4.1.1-1
Channel Access Priority Class (CAPC)

| Channel | | | | | | |
|---|---|---|---|---|---|---|
| Access | | | | | | |
| Priority | | | | | | |
| Class (p) | mₚ | CW_{min, p} | CW_{max, p} | T_{mcot, p} | | allowed CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

### 4.2.1 Channel Access Procedures for Uplink Transmission(s)

A UE shall use Type 1 channel access procedures for transmitting sounding reference signal (SRS) transmissions not including a PUSCH transmission. UL channel access priority class p=1 in Table 4.2.1-1 is used for SRS transmissions not including a physical uplink shared channel (PUSCH).

When a UE uses Type 1 channel access procedures for physical uplink control channel (PUCCH) transmissions or PUSCH only transmissions without UL-SCH, the UE shall use UL channel access priority class p=1 in Table 4.2.1-1.

A UE shall use Type 1 channel access procedure for physical random access channel (PRACH) transmissions and PUSCH transmissions without user plane data related to random access procedure that initiate a channel occupancy. In this case, UL channel access priority class p=1 in Table 4.2.1-1 is used for PRACH transmissions, and UL channel access priority class used for PUSCH transmissions is determined according to Clause 5.6.2 in 3GPP TS 38.300.

When a UE uses Type 1 channel access procedures for PUSCH transmissions on configured resource, the UE determines the corresponding UL channel access priority p in Table 4.2.1-1 following the procedures described in Clause 5.6.2 in 3GPP TS 38.300.

When a UE uses Type 1 channel access procedures for PUSCH transmissions with user plane data indicated by a UL grant or related to random access procedure where the corresponding UL channel access priority p is not indicated, the UE determines p in Table 4.2.1-1 following the same procedures as for PUSCH transmission on configured resources using Type 1 channel access procedures.

A UE shall not transmit on a channel for a Channel Occupancy Time that exceeds T_{ulm cot,p} where the channel access procedure is performed based on the channel access priority class p associated with the UE transmissions, as given in Table 4.2.1-1.

The total Channel Occupancy Time (COT) of autonomous uplink transmission(s) obtained by the channel access procedure in this clause, including the following DL transmission if the UE sets ‘COT sharing indication’ in autonomous uplink (AUL)-uplink control information (UCI) to ‘1’ in a subframe within the autonomous uplink transmission(s) as described in Clause 4.1.3, shall not exceed T_{ulm cot,p}, where T_{ulm cot,p} is given in Table 4.2.1-1.

TABLE 4.2.1-1
Channel Access Priority Class (CAPC) for UL

| Channel | | | | | |
|---|---|---|---|---|---|
| Access | | | | | |
| Priority | | | | | |
| Class | | | | | allowed CWₚ |
| (p) | mₚ | CW_{min, p} | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE 1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

### 4.2.1.1 Type 1 UL Channel Access Procedure

This clause describes channel access procedures by a UE where the time duration spanned by the sensing slots that are sensed to be idle before a UL transmission(s) is random. The clause is applicable to the following transmissions:
PUSCH/SRS transmission(s) scheduled or configured by eNB/gNB, or
PUCCH transmission(s) scheduled or configured by gNB, or
Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 μs immediately followed by mₚ consecutive slot durations where each slot duration is Tₛₗ=9 μs, and T_{f} includes an idle slot duration Tₛₗ at start of T_{f}.
CW_{min,p}≤CWₚ≤CW_{max,p} is the contention window. CWₚ adjustment is described in clause 4.2.2.
CW_{min,p} and CW_{max,p} are chosen before step 1 of the procedure above.
mₚ, CW_{min,p}, and CW_{max,p} are based on a channel access priority class p as shown in Table 4.2.1-1, that is signalled to the UE.

### From 3rd Generation Partnership Project (3GPP) TS 38.300

### 5.6.2 Channel Access Priority Classes

The Channel Access Priority Classes (CAPC) of radio bearers and medium access control (MAC) control elements (CEs) are either fixed or configurable for operation in frequency range 1 (FR1):
Fixed to the lowest priority for the padding buffer status reporting (BSR) and recommended bit rate MAC CEs;
Fixed to the highest priority for signal radio bearer (SRB) 0, SRB1, SRB3 and other MAC CEs;
Configured by the gNB for SRB2 and data radio bearer (DRB).

When choosing the CAPC of a DRB, the gNB takes into account the 5G quality of service indicators (5QIs) of all the quality of service (QoS) flows multiplexed in that DRB while considering fairness between different traffic types and transmissions. Table 5.6.2-1 below shows which CAPC should be used for which standardized 5QIs i.e. which CAPC to use for a given QoS flow.
NOTE: A QoS flow corresponding to a non-standardized 5QI (i.e. operator specific 5QI) should use the CAPC of the standardized 5QI which best matches the QoS characteristics of the non-standardized 5QI.

TABLE 5.6.2-1
Mapping between Channel Access Priority Classes and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

NOTE:
lower CAPC value means higher priority

When performing Type 1 LBT for the transmission of an uplink TB (see TS 37.213, clause 4.2.1.1) and when the CAPC is not indicated in the DCI, the UE shall select the CAPC as follows:
If only MAC CE(s) are included in the TB, the highest priority CAPC of those MAC CE(s) is used; or
If CCCH SDU(s) are included in the TB, the highest priority CAPC is used; or
If DCCH SDU(s) are included in the TB, the highest priority CAPC of the DCCH(s) is used; or
The lowest priority CAPC of the logical channel(s) with MAC SDU multiplexed in the TB is used otherwise.

### From 3GPP TS 38.300 v17.0.0

### 5.7 Sidelink

### 5.7.1 General

Sidelink supports UE-to-UE direct communication using the sidelink resource allocation modes, physical-layer signals/channels, and physical layer procedures below.

### 5.7.2 Sidelink Resource Allocation Modes

Two sidelink resource allocation modes are supported: mode 1 and mode 2. In mode 1, the sidelink resource allocation is provided by the network. In mode 2, UE decides the SL transmission resources in the resource pool(s).

### 5.7.3 Physical Sidelink Channels and Signals

Physical Sidelink Control Channel (PSCCH) indicates resource and other transmission parameters used by a UE for PSSCH. PSCCH transmission is associated with a DM-RS.

Physical Sidelink Shared Channel (PSSCH) transmits the TBs of data themselves, and control information for hybrid automatic repeat request (HARQ) procedures and channel state information (CSI) feedback triggers, etc. At least 6 OFDM symbols within a slot are used for PSSCH transmission. PSSCH transmission is associated with a DM-RS and may be associated with a PT-RS.

Physical Sidelink Feedback Channel (PSFCH) carries HARQ feedback over the sidelink from a UE which is an intended recipient of a PSSCH transmission to the UE which performed the transmission. PSFCH sequence is transmitted in one PRB repeated over two orthogonal frequency division multiplexing (OFDM) symbols near the end of the sidelink resource in a slot.

The Sidelink synchronization signal consists of sidelink primary and sidelink secondary synchronization signals (S-PSS, S-SSS), each occupying 2 symbols and 127 subcarriers. Physical Sidelink Broadcast Channel (PSBCH) occupies 9 and 5 symbols for normal and extended CP cases respectively, including the associated DM-RS.

### 5.7.4 Physical Layer Procedures for Sidelink

### 5.7.4.1 HARQ Feedback

Sidelink HARQ feedback uses PSFCH and can be operated in one of two options. In one option, which can be configured for unicast and groupcast, PSFCH transmits either acknowledge (ACK) or negative acknowledge (NACK) using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In sidelink resource allocation mode 1, a UE which received PSFCH can report sidelink HARQ feedback to gNB via PUCCH or PUSCH.

### 5.7.4.2 Power Control

For in-coverage operation, the power spectral density of the sidelink transmissions can be adjusted based on the pathloss from the gNB.

For unicast, the power spectral density of some sidelink transmissions can be adjusted based on the pathloss between the two communicating UEs.

### 5.7.4.3 CSI Report

For unicast, channel state information reference signal (CSI-RS) is supported for CSI measurement and reporting in sidelink. A CSI report is carried in a sidelink MAC CE.

### 5.7.5 Physical Layer Measurement Definition

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

### From 3GPP TS 36.843 v12.0.1

### 9.1.2 Resource Allocation

From a transmitting UE's perspective, a UE can operate in two modes for resource allocation:
Mode 1: eNodeB or Release-10 relay node schedules the exact resources used by a UE to transmit direct data and direct control information.
   FFS: if semi-static resource pool restricting the available resources for data and/or control is needed.
Mode 2: a UE on its own selects resources from resource pools to transmit direct data and direct control information.
   for further study (FFS): if the resource pools for data and control are the same.
   FFS: if semi-static and/or pre-configured resource pool restricting the available resources for data and/or control is needed.
device to device (D2D) communication capable UE shall support at least Mode 1 for in-coverage.
D2D communication capable UE shall support Mode 2 for at least edge-of-coverage and/or out-of-coverage.

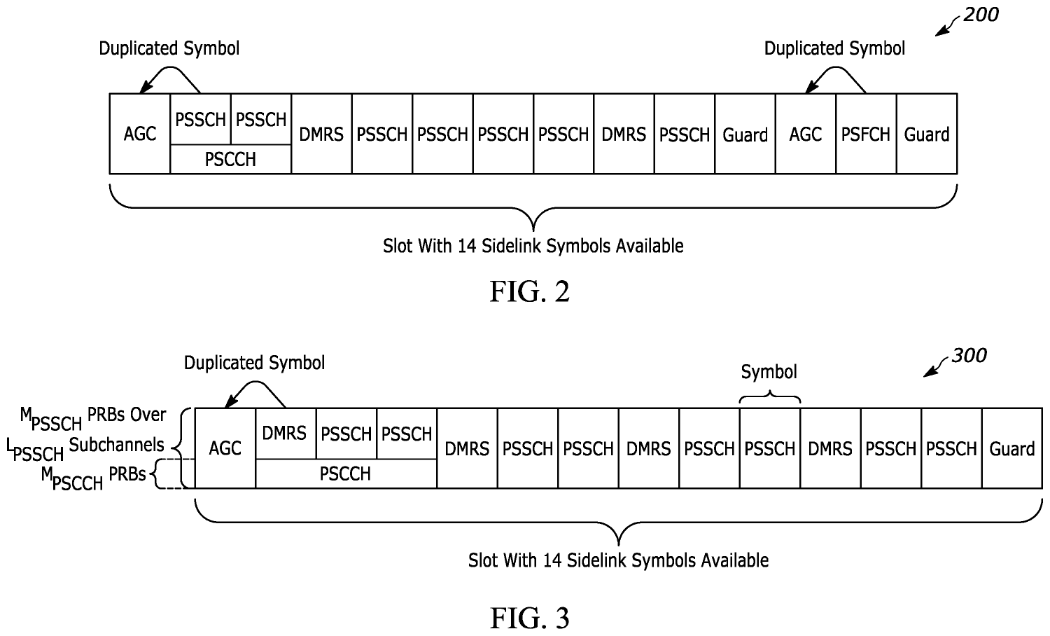

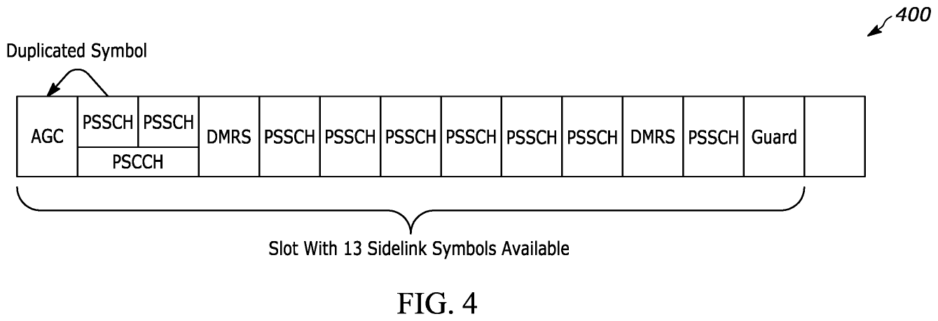

FIGS. 2-4 illustrate examples of a sidelink slot. More specifically, FIG. 2 illustrates a sidelink slot structure 200 with 14 symbols available, FIG. 3 illustrates a sidelink slot structure 300 with 14 symbols available, and FIG. 4 illustrates a sidelink slot structure 400 with 13 symbols available.

The sidelink slot structure contains automatic gain control (AGC) symbol at the beginning of the slot then PSCCH symbol followed by the PSSCH symbols and the last symbol in the slot is configured as a gap symbol (guard as shown in the FIGS. 2-4) to enable switching time from transmit (Tx) to receive (Rx).

Resource pool may be (pre)configured with one or two PSFCH symbol(s), using a PSFCH period of, for example, 1, 2, 4, 8 slots and the slots where the PSFCH occurs may be configured with additional AGC symbol and a gap symbols as seen from FIGS. 2-4 to enable switching from Tx to Rx for the reception of HARQ feedback.

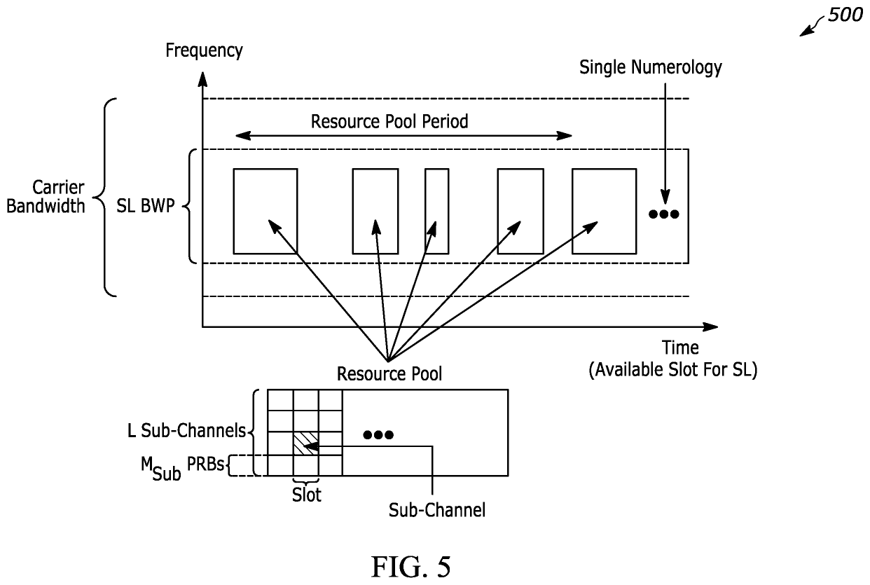

A resource pool (RP) can be shared by several UEs for their SL transmissions. A resource pool consists of contiguous physical resource blocks (PRBs) and contiguous or non-contiguous slots that have been (pre-)configured for sidelink (SL) transmissions. A resource pool must be defined within the SL bandwidth part (BWP) (See FIG. 5). FIG. 5 illustrates an exemplary resource pool (RP) structure 500.

An RP can be used for all transmission types (i.e., unicast, groupcast, and broadcast). A UE can be (pre-)configured with multiple RPs for transmission (transmit RPs) and with multiple RPs for reception (receive RPs). A UE can then receive data on resource pools used for SL transmissions by other UEs, while the UE can still transmit on the SL using its transmit resource pools. In the frequency domain, a resource pool is divided into a (pre-)configured number L of contiguous sub-channels, where a sub-channel consists of a group of consecutive PRBs in a slot. The number Msub of PRBs in a sub-channel corresponds to the sub-channel size, which is (pre-)configured within a resource pool. In NR V2X SL, the sub-channel size Msub can be equal to 10, 12, 15, 20, 25, 50, 75, or 100 PRBs. A sub-channel represents the smallest unit for a sidelink data transmission or reception.

A sidelink transmission can use one or multiple sub-channels. In the time domain, the slots that are part of a resource pool are (pre-)configured and occur with a periodicity of 10240 ms. The slots that are part of a resource pool can be (pre-)configured with a bitmap. The length of the bitmap can be equal to 10, 11, 12, . . . , 160. At each slot of a resource pool, only a subset of consecutive symbols are (pre-)configured for the sidelink, i.e., a subset out of the 14 or 12 symbols per slot for a normal or extended cyclical prefix (CP), respectively. The subset of SL symbols per slot is indicated with a starting symbol and a number of consecutive symbols, where these two parameters are (pre-)configured per resource pool. The number of consecutive SL symbols can vary between 7 and 14 symbols, e.g., depending on the physical channels which are carried within a slot (e.g., see FIGS. 2-4).

In accordance with at least one embodiment, the existing rules for UL/DL or new rules to a SL transmission are applied as a function of the traffic type or channel type that the Tx UE has used to initiate a COT.

In the following, one or more of the variables/parameters are used with these definitions:
mₚ is the number of consecutive slot durations employed in the defer duration: The defer duration T_{d} consists of duration T_{f}=16 μs immediately followed by mₚ consecutive slot durations where each slot duration is Tₛₗ=9 μs, and T_{f} includes an idle slot duration Tₛₗ at start of T_{f}.
CW_{min,p} is the minimum contention window size for channel access priority class p.
CW_{max,p} is the maximum contention window size for channel access priority class p.
T_{slm cot,p} is the maximum allowed channel occupancy time on sidelink for channel access priority class p.
allowed CWₚ sizes is the set of allowed values for CWₚ for determining a random number uniformly distributed between 0 and CWₚ.

According to an embodiment, when a UE uses a channel access procedure for sidelink transmissions, the UE uses a channel access priority class (CAPC) with at least one of the characteristics in Table 1.

TABLE 1
Channel Access Priority Classes for sidelink

| Priority | | | | | allowed CWₚ |
|---|---|---|---|---|---|
| class | mₚ | CW_{min, p} | CW_{max, p} | T_{smcot, p} | sizes |
| 1 | 2 | 3 | 7 | 2 ms | {3, 7} |
| (highest | | | | | |
| priority | | | | | |
| CAPC) | | | | | |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| (lowest | | | | | 255, 511, 1023} |
| priority | | | | | |
| CAPC) | | | | | |

According to an embodiment, when a UE uses Type 1 channel access procedures for PSFCH transmissions (with or without a symbol for purposes of automatic gain control (AGC)) the UE shall use sidelink (SL) channel access priority class p=1.

According to a further embodiment, when a UE uses Type 1 channel access procedures for PSSCH transmissions based on SL mode 1, where the corresponding SL channel access priority p is not indicated by the mode 1 grant given by the gNB, the UE determines the channel access priority class p following the same procedures as for PUSCH transmission on configured resources using Type 1 channel access procedures.

According to the further embodiment, when a UE uses Type 1 channel access procedures for PSSCH transmissions based on SL mode 2, the UE determines the corresponding SL channel access priority p following the procedures described in Clause 5.6.2 in 3GPP TS 38.300.

According to a fourth embodiment, when a UE uses Type 1 channel access procedures for PSSCH transmissions, the channel access parameters are determined differently depending on the traffic cast type.

If the traffic cast type is unicast, apply channel access parameters as for UL channel access. According to an implementation, the UE applies channel access parameters as for UL channel access if at least one of its transmissions within the channel occupancy time has a unicast traffic type. According to another implementation, the UE applies channel access parameters as for UL channel access if all its transmissions within the channel occupancy time have a unicast traffic type.

If the traffic cast type is groupcast or broadcast, apply channel access parameters as for DL channel access. According to an implementation, the UE applies channel access parameters as for DL channel access if at least one of its transmissions within the channel occupancy time has a groupcast or broadcast traffic type. According to another implementation, the UE applies channel access parameters as for DL channel access if all its transmissions within the channel occupancy time have a groupcast or broadcast traffic type.

The channel access parameters are one or more of
mₚ is the number of consecutive slot durations employed in the defer duration: The defer duration T_{d} consists of duration T_{f}=16 μs immediately followed by mₚ consecutive slot durations where each slot duration is Tₛₗ=9 μs, and T_{f} includes an idle slot duration Tₛₗ at start of T_{f}.
CW_{min,p} is the minimum contention window size for channel access priority class p.
CW_{max,p} is the maximum contention window size for channel access priority class p.
T_{slm cot,p} is the maximum allowed channel occupancy time on sidelink for channel access priority class p.
allowed CWₚ sizes is the set of allowed values for CWₚ for determining a random number uniformly distributed between 0 and CWₚ.

As presently described, several possible embodiments have been discussed. At least a couple of examples of discussed possible embodiments include:
Applying channel access priority class parameters depending on the cast type.
   For groupcast/broadcast traffic, apply parameters as for DL channel access.
   for unicast traffic, apply parameters as for UL channel access.
Defining the applicable priority class for PSFCH transmission.
Defining the applicable priority class determination for PSSCH transmissions.

Such a list only represents a partial list of the possible embodiments, as noted above.

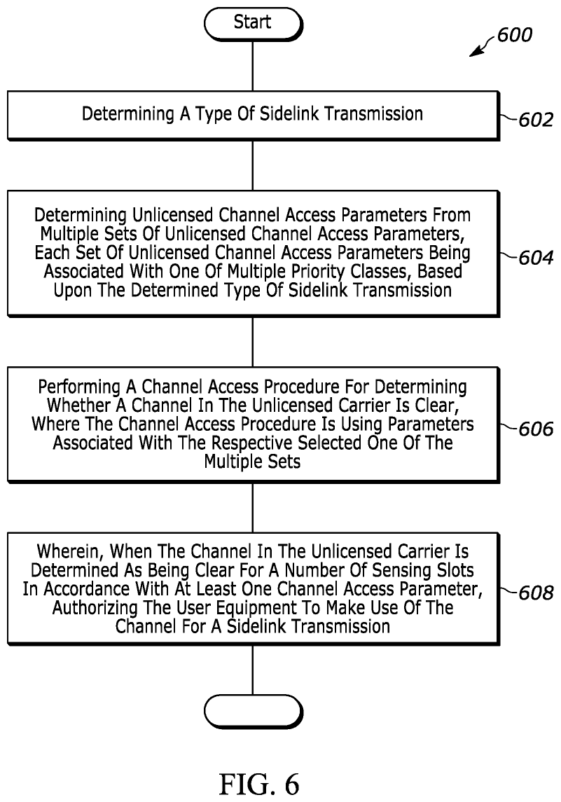

FIG. 6 illustrates a flow diagram 600 of a method in a user equipment. The method includes determining 602 a type of sidelink transmission. Unlicensed channel access parameters are determined 604 from multiple sets of unlicensed channel access parameters, each set of unlicensed channel access parameters being associated with one of multiple priority classes, based upon the determined type of sidelink transmission. A channel access procedure is performed 606 for determining whether a channel in the unlicensed carrier is clear, where the channel access procedure is using parameters associated with the respective selected one of the multiple sets. When the channel in the unlicensed carrier is determined as being clear for a number of sensing slots in accordance with at least one channel access parameter, the user equipment is authorized to make use of the channel for a sidelink transmission 608.

In some instances, the type of sidelink transmission can be associated with the use of a type 1 channel access procedure for a physical sidelink feedback channel, wherein the user equipment can use the highest channel access priority class and associated unlicensed channel access parameters from the multiple channel access priority classes and multiple sets of unlicensed channel access parameters.

In some instances, when the type of sidelink transmission is associated with the use of a type 1 channel access procedure for a physical sidelink shared channel, based on sidelink mode 1, where the corresponding sidelink channel access priority class is not indicated by the sidelink mode 1 grant given by the network, the user equipment can determine the channel access priority class following the same procedures as for physical uplink shared channel transmission on configured resources using type 1 channel access procedures.

In some instances, when the type of sidelink transmission is associated with the use of a type 1 channel access procedure for a physical sidelink shared channel, based on sidelink mode 2, a determination can be made as to the type of data included in the transport block. If only medium access control—control elements are included in the transport block, the highest priority channel access priority class of those medium access control—control elements can be used.

In some instances, when the type of sidelink transmission is associated with the use of a type 1 channel access procedure for a physical sidelink shared channel, based on sidelink mode 2, a determination can be made as to the type of data included in the transport block. If common control channel—service data units are included in the transport block, the highest priority channel access priority class can be used.

In some instances, when the type of sidelink transmission is associated with the use of a type 1 channel access procedure for a physical sidelink shared channel, based on sidelink mode 2, a determination can be made as to the type of data included in the transport block. If dedicated control channel—service data units are included in the transport block, the highest priority channel access priority class of the dedicated control channels can be used.

In some instances, when the type of sidelink transmission is associated with the use of a type 1 channel access procedure for a physical sidelink shared channel, based on sidelink mode 2, a determination can be made as to the type of data included in the transport block. if only medium access control—control elements are not included in the transport block, and if common control channel—service data units are not included in the transport block, and if dedicated control channel—service data units are not included in the transport block, then the lowest priority channel access priority code of the logical channels with medium access control—service data unit multiplexed in the transport block can be used.

In some instances, when a user equipment uses a type 1 channel access procedure for a physical sidelink shared channel, a traffic cast type can be determined. When at least one of the transmissions within the channel occupancy time has a traffic cast type that is unicast, the particular set of unlicensed channel access parameters being used can include the channel access parameters as for the uplink channel access for a physical uplink shared channel.

In some instances, when a user equipment uses a type 1 channel access procedure for a physical sidelink shared channel, a traffic cast type can be determined. When all of the transmissions within the channel occupancy time have a traffic cast type that is unicast, the particular set of unlicensed channel access parameters being used can includes the channel access parameters as for the uplink channel access for a physical uplink shared channel.

In some instances, when a user equipment uses a type 1 channel access procedure for a physical sidelink shared channel, a traffic cast type can be determined. When at least one of the transmissions within the channel occupancy time has a traffic cast type that is groupcast or broadcast, the particular set of unlicensed channel access parameters being used can include the channel access parameters as for the downlink channel access for a physical downlink shared channel.

In some instances, when a user equipment uses a type 1 channel access procedure for a physical sidelink shared channel, a traffic cast type can be determined. When all of the transmissions within the channel occupancy time have a traffic cast type that is groupcast or broadcast, the particular set of unlicensed channel access parameters being used can include the channel access parameters as for the downlink channel access for a physical downlink shared channel.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

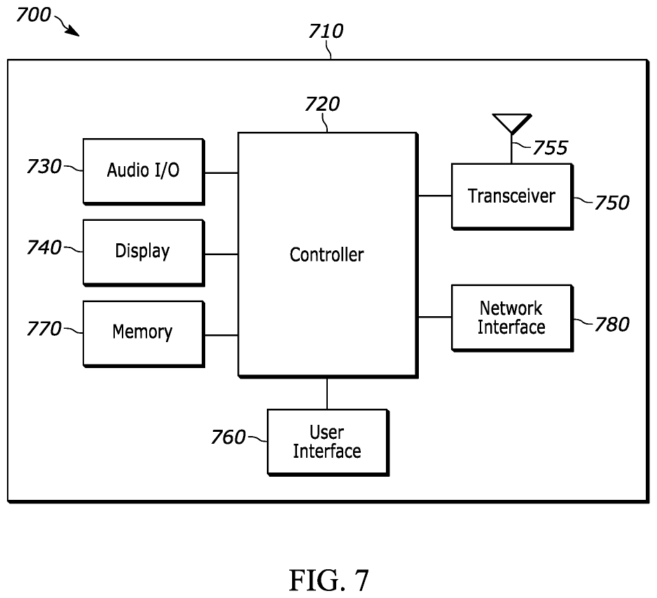

FIG. 7 is an example block diagram of an apparatus 700, such as the wireless communication device 110, according to a possible embodiment. The apparatus 700 can include a housing 710, a controller 720 within the housing 710, audio input and output circuitry 730 coupled to the controller 720, a display 740 coupled to the controller 720, a transceiver 750 coupled to the controller 720, an antenna 755 coupled to the transceiver 750, a user interface 760 coupled to the controller 720, a memory 770 coupled to the controller 720, and a network interface 780 coupled to the controller 720. The apparatus 700 can perform the methods described in all the embodiments.

The display 740 can be a viewfinder, a liquid crystal display (LCD), a light emitting diode (LED) display, a plasma display, a projection display, a touch screen, or any other device that displays information. The transceiver 750 can include a transmitter and/or a receiver. The audio input and output circuitry 730 can include a microphone, a speaker, a transducer, or any other audio input and output circuitry. The user interface 760 can include a keypad, a keyboard, buttons, a touch pad, a joystick, a touch screen display, another additional display, or any other device useful for providing an interface between a user and an electronic device. The network interface 780 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 770 can include a random access memory, a read only memory, an optical memory, a solid state memory, a flash memory, a removable memory, a hard drive, a cache, or any other memory that can be coupled to an apparatus.

The apparatus 700 or the controller 720 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 770 or elsewhere on the apparatus 700. The apparatus 700 or the controller 720 may also use hardware to implement disclosed operations. For example, the controller 720 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 720 may be any controller or processor device or devices capable of operating an apparatus and implementing the disclosed embodiments. Some or all of the additional elements of the apparatus 700 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

1. A user equipment (UE) for sidelink communication, the UE comprising:
at least one memory; and
at least one processor coupled with the at least one memory and configured to cause the UE to:
determine a type of sidelink transmission;
determine unlicensed channel access parameters from multiple sets of unlicensed channel access parameters based at least in part on the type of sidelink transmission, each set of unlicensed channel access parameters being associated with one of multiple priority classes;
perform a channel access procedure to determine whether a channel in an unlicensed carrier is clear, wherein the channel access procedure uses parameters associated with a selected one of the multiple sets; and
authorize the UE to use the channel for the sidelink transmission when the channel in the unlicensed carrier is determined as being clear for a number of sensing slots in accordance with at least one channel access parameter.

2. The UE of claim 1, wherein:
the type of the sidelink transmission is associated with a type 1 channel access procedure for a physical sidelink feedback channel (PSFCH); and
the at least one processor is configured to cause the UE to use a highest channel access priority class and associated unlicensed channel access parameters from multiple channel access priority classes and the multiple sets of unlicensed channel access parameters.

3. The UE of claim 1, wherein:
the type of the sidelink transmission is associated with a type 1 channel access procedure for a physical sidelink shared channel (PSSCH), based at least in part on sidelink mode 1, and a corresponding sidelink channel access priority class is not indicated by a sidelink mode 1 grant; and
the at least one processor is configured to cause the UE to determine a channel access priority class based at least in part on one or more procedures for physical uplink shared channel (PUSCH) transmission on configured resources using type 1 channel access procedures.

4. The UE of claim 1, wherein:
the type of the sidelink transmission is associated with a type 1 channel access procedure for a physical sidelink shared channel (PSSCH), based at least in part on sidelink mode 2; and
the at least one processor is configured to cause the UE to determine a type of data included in a transport block, and wherein, if only medium access control (MAC) control elements (CEs) are included in the transport block, then a highest priority channel access priority class of the MAC CEs is used.

5. The UE of claim 1, wherein:
the type of the sidelink transmission is associated with a type 1 channel access procedure for a physical sidelink shared channel (PSSCH), based at least in part on sidelink mode 2; and
the at least one processor is configured to cause the UE to determine a type of data included in a transport block, and wherein, if common control channel—service data units are included in the transport block, then a highest priority channel access priority class is used.

6. The UE of claim 1, wherein:
the type of the sidelink transmission is associated with a type 1 channel access procedure for a physical sidelink shared channel (PSSCH), based at least in part on sidelink mode 2; and
the at least one processor is configured to cause the UE to determine a type of data included in a transport block, and wherein, if dedicated control channel—service data units are included in the transport block, then a highest priority channel access priority class of the dedicated control channels is used.

7. The UE of claim 1, wherein:
the type of the sidelink transmission is associated with a type 1 channel access procedure for a physical sidelink shared channel (PSSCH), based at least in part on sidelink mode 2; and
the at least one processor is configured to cause the UE to determine a type of data included in a transport block;
if only medium access control (MAC) control elements (CEs) are not included in the transport block; and
if common control channel—service data units (SDUs) are not included in the transport block; and
then a lowest priority channel access priority code of logical channels with one or more MAC SDUs multiplexed in the transport block is used.

8. The UE of claim 1, wherein the at least one processor is configured to cause the UE to determine a traffic cast type based on a type 1 channel access procedure being used for a physical sidelink shared channel (PSSCH), and wherein if at least one transmission within a channel occupancy time has the traffic cast type that is unicast, then a set of unlicensed channel access parameters being used includes the channel access parameters for uplink (UL) channel access for a physical uplink shared channel (PUSCH).

9. The UE of claim 1, wherein the at least one processor is configured to cause the UE to determine a traffic cast type based on a type 1 channel access procedure being used for a physical sidelink shared channel (PSSCH), and wherein if all transmissions within a channel occupancy time have the traffic cast type that is unicast, then a set of unlicensed channel access parameters being used includes the channel access parameters for uplink (UL) channel access for a physical uplink shared channel (PUSCH).

10. The UE of claim 1, wherein the at least one processor is configured to cause the UE to determine a traffic cast type based on a type 1 channel access procedure being used for a physical sidelink shared channel (PSSCH), and wherein if all transmissions within a channel occupancy time have the traffic cast type that is groupcast or broadcast, then a set of unlicensed channel access parameters being used includes the channel access parameters for downlink (DL) channel access for a physical downlink shared channel (PDSCH).

11. A processor for wireless communication, the processor comprising:
at least one controller coupled with at least one memory and configured to cause the processor to:
determine a type of sidelink transmission;
determine unlicensed channel access parameters from multiple sets of unlicensed channel access parameters based at least in part on the type of sidelink transmission, each set of unlicensed channel access parameters being associated with one of multiple priority classes;
perform a channel access procedure to determine whether a channel in an unlicensed carrier is clear, wherein the channel access procedure uses parameters associated with a selected one of the multiple sets; and
authorize use of the channel for the sidelink transmission when the channel in the unlicensed carrier is determined as being clear for a number of sensing slots in accordance with at least one channel access parameter.

12. The processor of claim 11, wherein:
the type of the sidelink transmission is associated with a type 1 channel access procedure for a physical sidelink feedback channel (PSFCH); and
the at least one controller is configured to cause the processor to use a highest channel access priority class and associated unlicensed channel access parameters from multiple channel access priority classes and the multiple sets of unlicensed channel access parameters.

13. (canceled)

14. The processor of claim 11, wherein:
the type of the sidelink transmission is associated with a type 1 channel access procedure for a physical sidelink shared channel (PSSCH), based at least in part on sidelink mode 2; and
the at least one controller is configured to cause the processor to determine a type of data included in a transport block, and wherein, if common control channel-service data units are included in the transport block, then a highest priority channel access priority class is used.

15. (canceled)

16. The processor of claim 11, wherein:
the type of the sidelink transmission is associated with a type 1 channel access procedure for a physical sidelink shared channel (PSSCH), based at least in part on sidelink mode 2; and
the at least one controller is configured to cause the processor to determine a type of data included in a transport block;
if only medium access control (MAC) control elements (CEs) are not included in the transport block; and
if common control channel—service data units (SDUs) are not included in the transport block;
then a lowest priority channel access priority code of logical channels with one or more MAC SDUs multiplexed in the transport block is used.

17-19. (canceled)

20. A method performed by a user equipment (UE) for sidelink communication, the method comprising:
determining a type of sidelink transmission;
determining unlicensed channel access parameters from multiple sets of unlicensed channel access parameters based at least in part on the type of sidelink transmission, each set of unlicensed channel access parameters being associated with one of multiple priority classes;
performing a channel access procedure for determining whether a channel in an unlicensed carrier is clear, wherein the channel access procedure uses parameters associated with a selected one of the multiple sets; and
authorizing the UE to use the channel for the sidelink transmission when the channel in the unlicensed carrier is determined as being clear for a number of sensing slots in accordance with at least one channel access parameter.

21. The method of claim 20, wherein:
the type of the sidelink transmission is associated with a type 1 channel access procedure for a physical sidelink feedback channel (PSFCH); and the method further comprising:
using highest channel access priority class and associated unlicensed channel access parameters from multiple channel access priority classes and the multiple sets of unlicensed channel access parameters.

22. The method of claim 20, wherein:
the type of the sidelink transmission is associated with a type 1 channel access procedure for a physical sidelink shared channel (PSSCH), based at least in part on sidelink mode 1, and a corresponding sidelink channel access priority class is not indicated by a sidelink mode 1 grant; and the method further comprising:
determining a channel access priority class based at least in part on one or more procedures for physical uplink shared channel (PUSCH) transmission on configured resources using type 1 channel access procedures.

23. The method of claim 20, wherein:
the type of the sidelink transmission is associated with a type 1 channel access procedure for a physical sidelink shared channel (PSSCH), based at least in part on sidelink mode 2; and the method further comprising:
determining a type of data included in a transport block, and wherein, if only medium access control (MAC) control elements (CEs) are included in the transport block, then a highest priority channel access priority class of the MAC CEs is used.

24. The method of claim 20, wherein:
the type of the sidelink transmission is associated with a type 1 channel access procedure for a physical sidelink shared channel (PSSCH), based at least in part on sidelink mode 2; and the method further comprising:
determining a type of data included in a transport block, and wherein, if common control channel—service data units are included in the transport block, then a highest priority channel access priority class is used.

25. The method of claim 20, wherein:
the type of the sidelink transmission is associated with a type 1 channel access procedure for a physical sidelink shared channel (PSSCH), based at least in part on sidelink mode 2; and the method further comprising:
determining a type of data included in a transport block;
if only medium access control (MAC) control elements (CEs) are not included in the transport block; and
if common control channel—service data units (SDUs) are not included in the transport block;
then a lowest priority channel access priority code of logical channels with one or more MAC SDUs multiplexed in the transport block is used.
